(19) United States
(12) Patent Application Publication
(10) Pub. No.: US 2021/0048825 A1
(43) Pub. Date: Feb. 18, 2021

(54) PREDICTIVE AND REACTIVE FIELD-OF-VIEW-BASED PLANNING FOR AUTONOMOUS DRIVING

(71) Applicant: GM Global Technology Operations LLC, Detroit, MI (US)

(72) Inventors: Thanura Ranmal Elvitigala, Albuquerque, NM (US); Pinaki Gupta, Novi, MI (US); Sayyed Rouhollah Jafari Tafti, Troy, MI (US)

(21) Appl. No.: 16/539,306

(22) Filed: Aug. 13, 2019

(51) Int. Cl. G05D 1/02; G01C 21/34

(52) U.S. Cl. CPC G05D 1/0217; G05D 1/0274; G05D 2201/0213; G01C 21/3469; G01C 21/3415; G05D 1/0214

(57) ABSTRACT

Systems and methods to control an autonomous vehicle to travel from an origin to a destination include determining a route between the origin and the destination using a map. A method includes determining an initial path along the route by optimizing a first cost function, the first cost function including a static cost component at a first set of locations along the route, and the static cost component at each location among the first set of locations along the route corresponding to a change in field of view of one or more sensors of the autonomous vehicle resulting from one or more static obstructions at the location that are indicated on the map. The method also includes controlling the autonomous vehicle to begin the travel on the route along the initial path.

### INTRODUCTION

The subject disclosure relates to predictive and reactive field-of-view-based planning for autonomous driving.

Autonomous operation of vehicles relies on one or more types of sensors to detect and monitor both the vehicle and its environment. Exemplary vehicles include automobiles, trucks, motorcycles, construction equipment, farm equipment, automated factory equipment. Exemplary sensors include light detection and ranging (lidar) systems, radio detection and ranging (radar) systems, and cameras. Most sensors have a nominal field of view (FOV) associated with them, and the sensors detect objects or obtains images within their respective FOV. The nominal FOV of one or more sensors of an autonomous vehicle are considered for planning the future trajectory of the vehicle. For example, a static route plan is developed for travel from a given origin to a given destination. This route plan is then used during travel, along with detection data from the nominal FOV of the sensors, to generate a dynamic trajectory which dictates path points and velocities of the vehicle. But, the nominal FOV of a given sensor may be reduced because of an occlusion. Occlusions may be static (e.g., buildings, bushes) or dynamic (e.g., other vehicles in a current path). Accordingly, it is desirable to provide predictive and reactive field-of-view-based planning for autonomous driving.

### SUMMARY

In one exemplary embodiment, a method of controlling an autonomous vehicle to travel from an origin to a destination includes determining a route between the origin and the destination using a map. The method also includes determining an initial path along the route by optimizing a first cost function, the first cost function including a static cost component at a first set of locations along the route, and the static cost component at each location among the first set of locations along the route corresponding to a change in field of view of one or more sensors of the autonomous vehicle resulting from one or more static obstructions at the location that are indicated on the map. The method further includes controlling the autonomous vehicle to begin the travel on the route along the initial path.

In addition to one or more of the features described herein, the method also includes dynamically modifying the initial path in real time during the travel.

In addition to one or more of the features described herein, the modifying the initial path includes optimizing a second cost function in real time.

In addition to one or more of the features described herein, the optimizing the second cost function includes using a dynamic cost component at a second set of locations along the route, the dynamic cost component at each location among the second set of locations along the route corresponding to the change in field of view of the one or more sensors of the autonomous vehicle resulting from one or more static and dynamic obstructions at the location, wherein the dynamic obstructions include other vehicles.

In addition to one or more of the features described herein, the second set of locations and the first set of locations have one or more locations in common.

In addition to one or more of the features described herein, the method also includes determining the change in field of view of the one or more sensors of the autonomous vehicle at two or more grid points at each of the second set of locations.

In addition to one or more of the features described herein, the method also includes estimating a degree of occlusion at each of the two or more grid points and providing the degree of occlusion at each of the two or more grid points at each of the second set of locations as the dynamic cost component. The estimating the degree of occlusion includes obtaining a harmonic mean.

In addition to one or more of the features described herein, the optimizing the first cost function and the optimizing the second cost function include performing an algorithmic cost minimization process.

In addition to one or more of the features described herein, the method also includes determining the change in field of view of the one or more sensors of the autonomous vehicle at two or more grid points at each of the first set of locations.

In addition to one or more of the features described herein, the method also includes estimating a degree of occlusion at each of the two or more grid points and providing the degree of occlusion at each of the two or more grid points at each of the first set of locations as the static cost component. The estimating the degree of occlusion includes obtaining a harmonic mean.

In another exemplary embodiment, a system to control an autonomous vehicle to travel from an origin to a destination includes a memory device to store a map, and a controller to determine a route between the origin and the destination. The controller also determines an initial path along the route by optimizing a first cost function, the first cost function including a static cost component at a first set of locations along the route, and the static cost component at each location among the first set of locations along the route corresponding to a change in field of view of one or more sensors of the autonomous vehicle resulting from one or more static obstructions at the location that are indicated on the map. The controller further controls the autonomous vehicle to begin the travel on the route along the initial path.

In addition to one or more of the features described herein, the controller dynamically modifies the initial path in real time during the travel.

In addition to one or more of the features described herein, the controller modifies the initial path by optimizing a second cost function in real time.

In addition to one or more of the features described herein, the controller optimizes the second cost function by using a dynamic cost component at a second set of locations along the route, the dynamic cost component at each location among the second set of locations along the route corresponding to the change in field of view of the one or more sensors of the autonomous vehicle resulting from one or more static and dynamic obstructions at the location, and the dynamic obstructions including other vehicles.

In addition to one or more of the features described herein, the second set of locations and the first set of locations have one or more locations in common.

In addition to one or more of the features described herein, the controller determines the change in field of view of the one or more sensors of the autonomous vehicle at two or more grid points at each of the second set of locations.

In addition to one or more of the features described herein, the controller estimates a degree of occlusion at each of the two or more grid points and provide the degree of occlusion at each of the two or more grid points at each of the second set of locations as the dynamic cost component, and estimating the degree of occlusion includes obtaining a harmonic mean.

In addition to one or more of the features described herein, the controller optimizes the first cost function and optimize the second cost function by performing an algorithmic cost minimization process.

In addition to one or more of the features described herein, the controller determines the change in field of view of the one or more sensors of the autonomous vehicle at two or more grid points at each of the first set of locations.

In addition to one or more of the features described herein, the controller estimates a degree of occlusion at each of the two or more grid points and to provide the degree of occlusion at each of the two or more grid points at each of the first set of locations as the static cost component, and estimating the degree of occlusion includes obtaining a harmonic mean.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a vehicle that implements predictive and reactive field-of-view-based planning for autonomous driving according to one or more embodiments;

FIG. 2 is an exemplary map used to perform autonomous driving using predictive and reactive field-of-view-based planning according to one or more embodiments;

FIG. 3 is a process flow of a method of performing autonomous driving using predictive and reactive field-of-view-based planning according to one or more embodiments;

FIG. 4 illustrates aspects of predictive field-of-view-based planning according to one or more embodiments;

FIG. 5 illustrates estimation of degree of occlusion (DOO) for a grid point as part of predictive field-of-view-based planning according to one or more embodiments;

FIG. 6 is a process flow of a method that further details aspects of the reactive field-of-view-based planning in the method shown in FIG. 3; and

FIG. 7 illustrates estimation of DOO for a grid point as part of reactive field-of-view-based planning according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, autonomous driving involves planning a static route that the autonomous vehicle will take and a dynamic trajectory that defines specific path points and velocity along that route. The static route provides a lane-level path from the origin to the destination without considering the presence of any other vehicles. This static route is then modified during the travel to consider dynamic objects on the road using a real-time trajectory planner. Both static and dynamic planning use a map that indicates roads, direction of travel permitted on the roads, lane lines, and other information that facilitates autonomously traversing between an origin and a destination. The route plan may indicate the lanes to be used to reach the designated destination and the speed along each part of the route, for example. The trajectory plan may specify a more detailed position and velocity for the autonomous vehicle along the route (e.g., centered between the lane lines, to the right of the lane). Generally, a cost function with several cost components is optimized to determine the trajectory plan (e.g., path, speed). An exemplary cost component may be the distance to other vehicles. That is, the cost increases as the distance to other vehicles decreases. Thus, a path in the center of a center lane or to the right in a right lane may be determined based on optimizing the cost function.

The cost function may use a number of other cost components to optimize the path and vehicle operation along the route to the destination. In addition, the cost function may be used to optimize the path at two different stages. Prior to traversing the route, the nominal path points (i.e., the center line of the lanes in the route) may be adjusted by optimizing the cost function based on map information. During traversal of the route, in real time, the initial route plan may be updated by optimizing the cost function periodically or at irregular intervals based on an event or particular location, for example.

Embodiments of the systems and methods detailed herein add effective field of view (eFOV) as a cost component to the cost function to provide predictive and reactive field-of-view-based planning for autonomous driving. Predictive field-of-view-based planning refers to considering eFOV as part of the cost function analysis prior to traversing the route. Reactive field-of-view-based planning refers to considering eFOV as part of the cost function analysis during traversal of the route. Predictive field-of-view-based planning is performed by considering static obstructions (e.g., buildings, billboards, fences, intersection geometry) that are indicated along the route on the map. Reactive field-of-view-based planning is performed dynamically during the drive along the route by considering static and dynamic obstructions (e.g., other vehicles, pedestrians) encountered along the route.

Generally, according to one or more embodiments, in both predictive field-of-view-based planning (i.e., the pre-travel route planning) and reactive field-of-view-based planning (i.e., the during-travel trajectory planning), one of the cost optimization goals is to maximize eFOV (i.e., minimize occlusions for the sensors of the autonomous vehicle). Both predictive and reactive field-of-view-based planning use the estimation of degree of occlusion (DOO) as the cost component introduced into the cost optimization process according to one or more embodiments. The DOO and, specifically, decrease in DOO, corresponds with an increase in eFOV. Thus, an estimation of DOO, obtained as detailed herein, is representative of eFOV in the cost function.

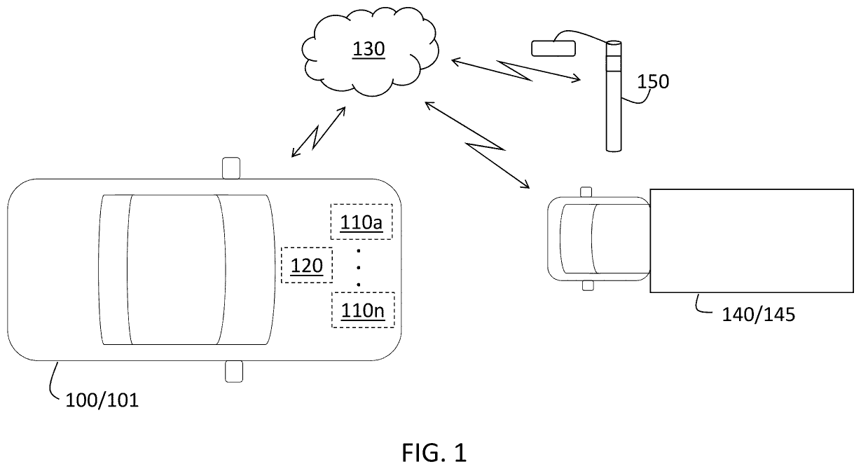

In accordance with an exemplary embodiment, FIG. 1 is a block diagram of a vehicle 100 that implements predictive and reactive field-of-view-based planning for autonomous driving. The exemplary vehicle 100 shown in FIG. 1 is an automobile 101. The vehicle 100 includes sensors 110a through 110n (generally referred to as 110). Exemplary sensors 110 include one or more radar systems, lidar systems, and cameras. Based on its type and its location around the vehicle 100, each sensor 110 has a different nominal FOV that is known. References to FOV or eFOV herein take into consideration the entire suite of sensors 110 of the vehicle 100. That is, the eFOV is not reduced from the nominal FOV even if the view of one of the sensors 110 of the vehicle 100 is occluded if the view of one or more other sensors 110 is not. The FOV and eFOV of the set of sensors 110 of the vehicle 100 is considered.

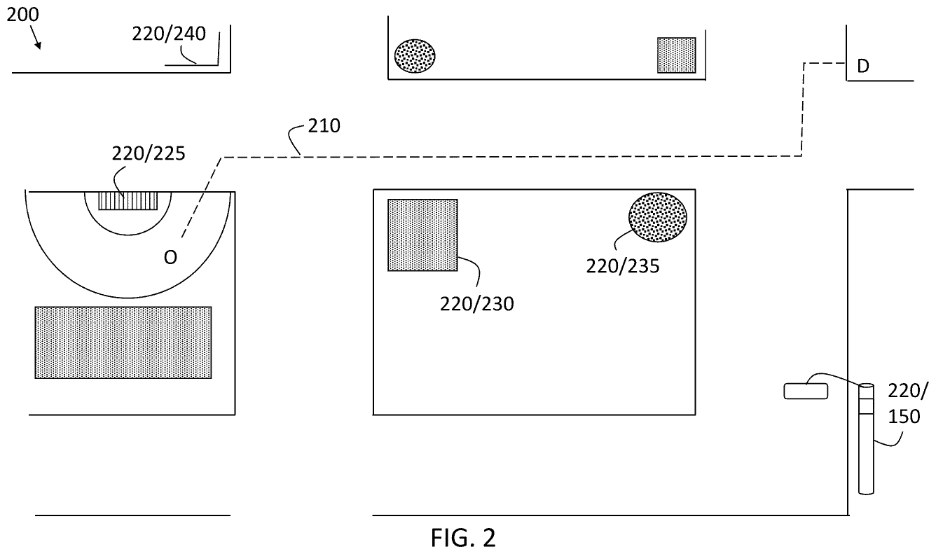

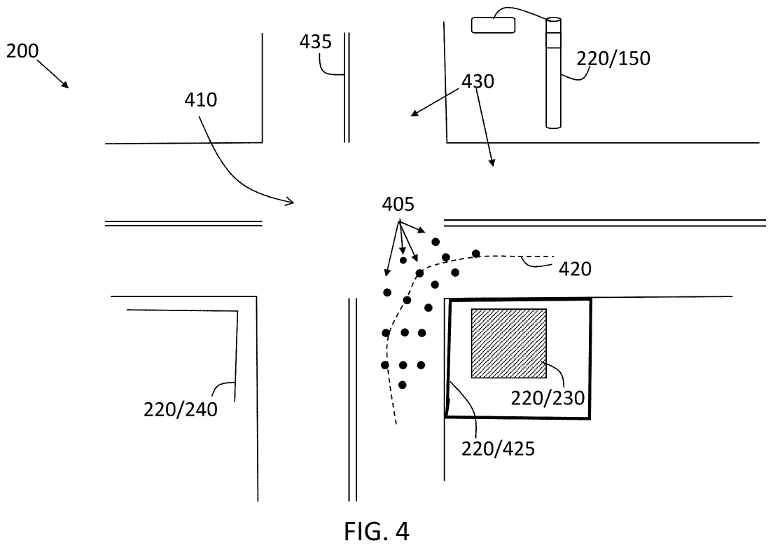

The vehicle 100 also includes a controller 120. The controller 120 may control one or more aspects of the operation of the vehicle 100 based on information from the sensors 110. According to one or more exemplary embodiments, the controller 120 performs predictive field-of-view-based planning to determine an initial path 420 (FIG. 4) along a route 210 (FIG. 2) prior to the vehicle 100 beginning a trip along the route 210. The controller 120 then performs modification of the initial path 420 in real time during the trip along the route 210 as part of reactive field-of-view-based planning. As previously noted, the initial path 420 may follow the center line of the lanes in the route, for example. The controller 120 may also include components that facilitate communication. For example, the vehicle 100 may perform vehicle-to-vehicle (V2V) communication with another vehicle 140, the truck 145, shown in FIG. 1 or vehicle-to-infrastructure (V2I) or vehicle-to-everything (V2X) communication with the communication circuitry within the light post 150 shown in FIG. 1. The communication may be direct or via a cloud server 130, as shown. In addition to communication components, the controller 120 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. As detailed herein, the controller 120 implements predictive and reactive field-of-view-based planning for autonomous driving according to one or more embodiments.

FIG. 2 is an exemplary map 200 used to perform autonomous driving using predictive and reactive field-of-view-based planning according to one or more embodiments. The map 200 is used to exemplify the type of information conveyed rather than to illustrate and limit the level of definition or actual look of the map used by the controller 120 to plan a route 210 or identify static obstructions 220. A route 210 is indicated from an origin 0 to a destination D. The exemplary static obstructions 220 shown in FIG. 2 include a light post 150, hedges 225, buildings 230, trees 235, and a fence 240. Once the route 210 is determined, predictive field-of-view-based planning is performed to determine a specific initial path 420 (FIG. 4) along the route 210 based on the static obstructions 220 in the map. Then, during travel, reactive field-of-view-based planning is performed in real time to modify the initial path 420 along the route 210, considering the dynamic obstructions (e.g., other vehicles 140).

As previously noted, the trajectory planning includes optimizing a cost function. That is, a set of cost components are considered and a known process of cost function minimization is implemented. Exemplary cost components may include lane keeping (i.e., cost increases as the vehicle 100 departs from the lane 430 (FIG. 4)) and, in the real-time trajectory planning, distance to other vehicles 140 (i.e., cost increases as the vehicle 100 gets closer to other vehicles 140). According to one or more embodiments of the invention, predictive field-of-view-based planning includes providing an estimate of DOO resulting from static obstructions 220 as one of the cost components for determining the initial path 420. According to one or more embodiments of the invention, reactive field-of-view-based planning includes providing an estimate of DOO in real time resulting from static obstructions 220 and dynamic obstructions (i.e., other vehicles 140) as one of the cost components for determining a modification to the initial path 420.

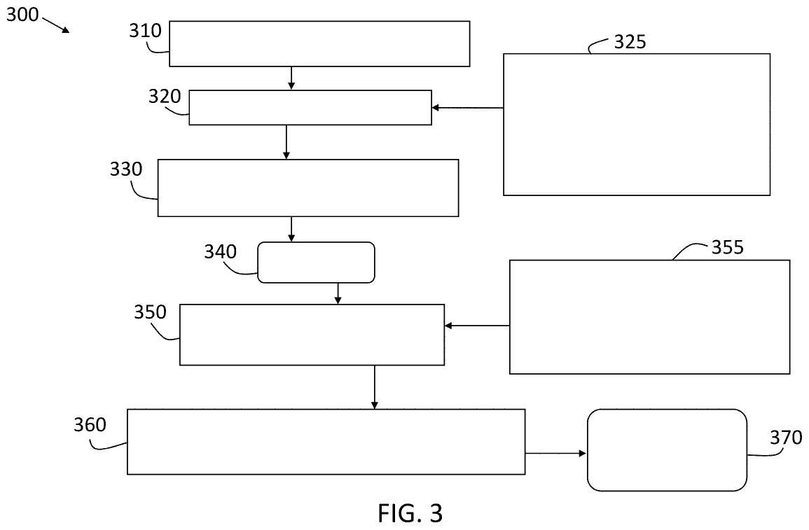

FIG. 3 is a process flow of a method 300 of performing autonomous driving using predictive and reactive field-of-view-based planning according to one or more embodiments. At block 310, determining a route 210 to the destination refers to the controller 120 using a map 200 to plot a course between the starting location of the vehicle 100 and the destination D. At block 320, optimizing a cost function refers to an algorithmic approach to minimize total cost. In the relevant context of path selection, optimizing the cost function refers to determining a cost associated with two or more paths and selecting the path among those two or more paths that is associated with minimum cost. Each path is defined by two or more positions (e.g. gird points 405 (FIG. 4)) and the cost associated with the path refers to the sum of the cost associated with each position that makes up the path. The cost associated with each position is a sum of the cost components at the position.

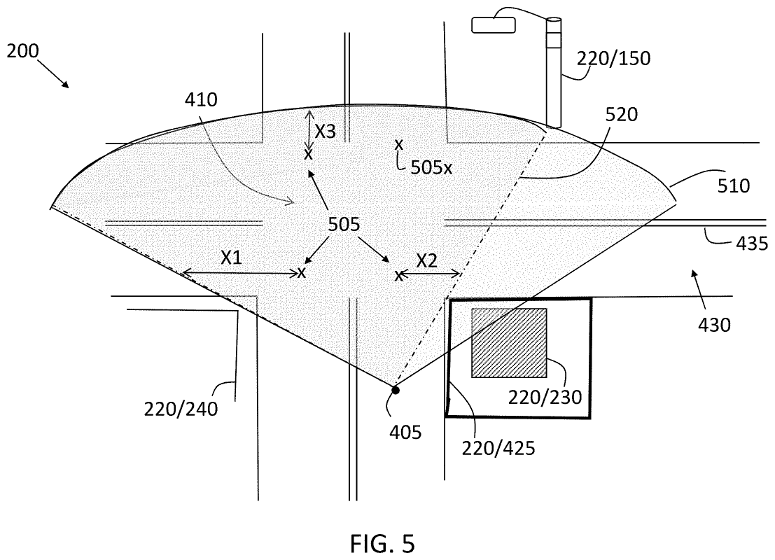

At block 325, to perform predictive field-of-view-based planning according to one or more embodiments, the processes include estimating DOO at locations of interest along the route 210 based on static obstructions 220 indicated on the map 200. This is further discussed with reference to FIGS. 4 and 5. As noted, the DOO estimates at the first locations of interest (estimated at block 325) are provided as a cost component for optimization of the cost function, at block 320. That is, while optimization of the cost function (at block 320) may be performed at any number of locations along the route 210, the estimation of DOO based on static obstructions 220 (at block 325) may be performed at a subset of those locations (referred to for explanatory purposes as the first locations of interest). The optimization at block 320 results in generating an initial path 420 (FIG. 4), at block 330. Based on the initial path 420, the processes include starting the trip at block 340.

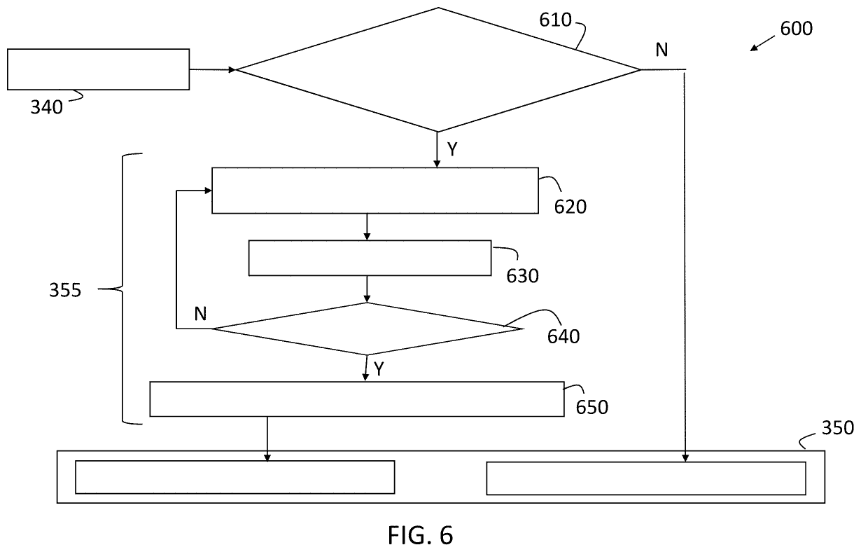

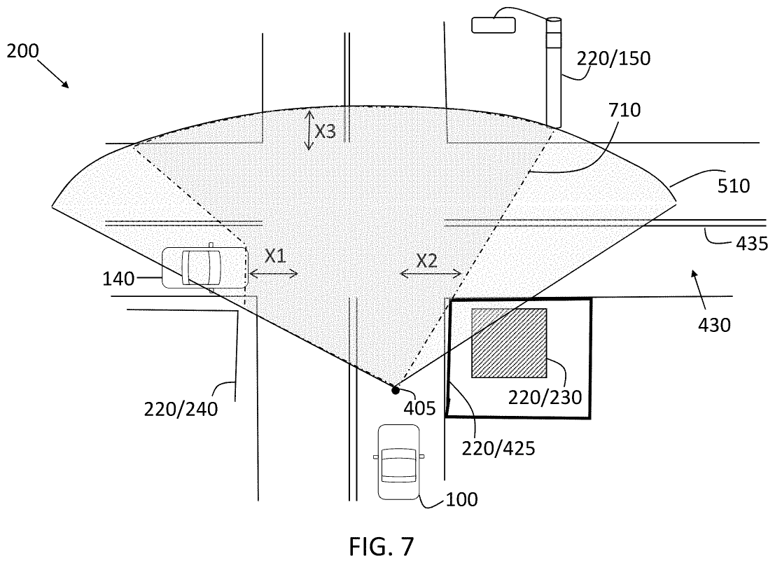

During the trip, the processes include optimizing the cost function in real time at block 350. As part of reactive field-of-view-based planning, the cost function includes a cost component, obtained from block 355, for second locations of interest. At block 355, the processes include estimating DOO at locations of interest based on static obstructions 220 and dynamic obstructions such as other vehicles 140. This is further discussed with reference to FIGS. 6 and 7. As noted, the DOO estimates at the second locations of interest (estimated at block 355) are provided as a cost component for optimization of the cost function, at block 350. That is, while optimization of the cost function (at block 350) may be performed at any number of locations along the route 210, the estimation of DOO based on static obstructions 220 and dynamic obstructions such as other vehicles 140 (at block 325) may be performed at a subset of those locations (referred to for explanatory purposes as the second locations of interest).

The optimization of the cost function (at block 320) at all locations of interest along the route 210, which may include a cost component indicating estimates of DOO (at block 325) at first locations of interest as part of predictive field-of-view-based planning, is performed altogether for the entire route 210. This results in the initial path 420 being determined prior to the vehicle 100 traversing the route 210. However, optimization of the cost function (at block 350) at all locations of interest along the route 210, which may include a cost component indicating estimates of DOO (at block 355) at second locations of interest as part of reactive field-of-view-based planning, is performed piecemeal, in real time, as each location of interest is approached by the vehicle 100. The first locations of interest and the second locations of interest may be different, the same, or may overlap. Based on the optimized cost function, at block 350, modifying the initial path 420 at a given location along the route 210 may be performed in real time, at block 360. Reaching the destination D, at block 370, ends the process flow of the method 300.

FIG. 4 illustrates aspects of predictive field-of-view-based planning according to one or more embodiments. An exemplary intersection 410 is shown as one of the first locations of interest for the process at block 325 (FIG. 3). Lanes 430 are shown divided by double lane lines 435. This intersection 410 may be a portion of the map 200 used in planning and executing a trip by the vehicle 100. Static obstructions 220 shown in FIG. 4 include a wall 425, a building 230, a fence 240, and a light post 150. Grid points 405 indicate different positions of the vehicle 100 that are considered in order to provide the cost component from block 325 to block 320 (FIG. 3) for optimization of the cost function. Specifically, at each grid point 405, the eFOV is determined. The eFOV may be a reduced FOV from the nominal FOV due to the static obstructions 220. This eFOV is used to estimate DOO, as detailed with reference to FIG. 5.

Once the DOO corresponding with each grid point 405 is estimated, the position of the grid point 405 and corresponding DOO may be provided as a cost component (from block 325 to block 320). The cost function minimization that occurs at block 320 considers the cost component associated with DOO at each of the grid points 405 (from block 325), as well as other cost components such as deviation from the initial path 420, steering cost (i.e., how much steering is needed to follow a set of grid points 405). The result of the optimization of the cost function is the initial path 420, indicated in FIG. 4. The initial path 420 is comprised of the particular set of grid points 405 that result in the minimum cost among considered sets of grid points 405. As previously noted, the DOO estimation (at block 325) may not be of interest at every location for which the cost function is optimized (at block 320). Thus, while DOO estimation at different grid points 405 is provided at the first locations of interest (e.g., the intersection 410), at other locations, the cost function may not include a cost component that conveys eFOV. As also previously noted, the determination of the initial path 420 along the route 210 is determined at the first locations of interest and at any other locations of interest (which do not include DOO estimation as a cost component) prior to commencement of travel by the vehicle 100 along the route 210.

FIG. 5 illustrates estimation of DOO for a grid point 405 as part of predictive field-of-view-based planning according to one or more embodiments. One exemplary grid point 405 among those shown in FIG. 4 is shown in FIG. 5. This grid point 405 represents one possible position of the vehicle 100 (of the center of the front, for example). The nominal FOV 510 of sensors 110 (FIG. 1) of the vehicle 100 is indicated. Because of the wall 425 that acts as a static obstruction 220 from the position of the grid point 405, the eFOV 520, which is also indicated, is reduced from the FOV 510. The fence 240 and the light post 150 are not positioned to affect the nominal FOV 510 at the position of the grid point 405. Based on the eFOV 520, the distances X1, X2, and X3 are determined. Each of these distances X1, X2, or X3 is a distance from a designated intersection point 505 on the map 200 to the closest boundary of the eFOV 520.

Only intersection points 505 that are relevant to the route 201 mapped for the vehicle 100 are used. For example, assuming that driving on the right side of the road is legal, X1, X2, and X3 all relate to lanes 430 at which or from which potential colliding vehicles 140 with the vehicle 100 could be. However, the intersection point 505x represents a lane 430 in which any vehicle 140 should be travelling away from the vehicle 100 represented by the grid point 405. For a time period that represents a planning horizon T in seconds (e.g., 5-6 seconds), the DOO corresponding with the exemplary grid point 405 shown in FIG. 5 may be estimated using a harmonic mean as:

$$DOO = \frac{HarmonicMean ( T \frac{{X}_{1}}{v 1} , T - \frac{{X}_{2}}{v 2} , T - \frac{{X}_{3}}{v 3} )}{T} \qquad [ EQ . 1 ]$$

In EQ. 1, v1, v2, and v3 are the nominal speeds in the respective lanes 430. These nominal speeds (e.g., speed limit) are listed in the map 200. As FIG. 5 indicates, v1 and v2 may be the same value because they relate to the same lane 430 of travel. As previously noted, a DOO estimate, according to EQ. 1,is determined for every grid point 405 at a given location of interest among the first locations of interest (at block 325, FIG. 3). The grid points 405 and corresponding DOO estimates are provided as one of the cost components for cost function minimization at block 320 (FIG. 3) in order to obtain the initial path 420 (at block 330, FIG. 3).

FIG. 6 is a process flow of a method 600 that further details aspects of the reactive field-of-view-based planning in the method 300 shown in FIG. 3. At block 340, starting the trip refers to the vehicle 100 following the initial path 420 (FIG. 4). This initial path 420 is generated at block 330 (FIG. 3) based, in part, on the predictive field-of-view-based planning that uses estimates of DOO resulting from static obstructions 220, as detailed with reference to FIGS. 4 and 5. The process flow shown in FIG. 6 is repeated as the vehicle 100 approaches each location of interest. Locations of interest may be intersections 410 (FIG. 4) at which the vehicle 100 will make a turn or areas where the real time scene differs from the map 200 due to construction, for example. In general, a location of interest is one at which any of the cost components may have changed from those considered (at block 320, FIG. 3) in generating the initial path 420.

At block 610, a check is done of whether the location of interest that the vehicle 100 is approaching is also a second location of interest. As previously noted, for explanatory purposes, second locations of interest are a reference to locations at which reactive field-of-view-based planning is needed. That is, the check at block 610 determines if the cost component associated with DOO may have changed from the cost component provided (from block 325, FIG. 3) because of dynamic obstructions such as other vehicles 140. If the location of interest is not also a second location of interest, then cost function optimization (at block 350, FIG. 3) is performed with cost components that do not include any DOO estimate.

If the location of interest is also a second location of interest, according to the check at block 610, then a process flow similar to the one described with reference to FIGS. 4 and 5 is undertaken with the exception that dynamic obstructions such as other vehicles 140 are also considered in the determination of eFOV which then affects DOO estimate. At block 620, selecting a grid point 405 (FIG. 4) refers to choosing one of two or more alternate future positions for the vehicle 100 at the second location of interest. Calculating DOO, at block 630, for the selected grid point 405 involves using EQ. 1. This is further discussed with reference to FIG. 7. At block 640, a check is done of whether the current grid point 405 is the last one (i.e., all other grid points 405 have been processed). If the current grid point 405 is not the last, then another iteration beginning with selection of another grid point 405, at block 620, is implemented. If the current grid point 405 is the last one, then the grid points 405 and corresponding DOO values are provided as a cost component, at block 650, for cost function optimization at block 350. Other exemplary cost components, which are additional to those discussed with reference to predictive field-of-view-based planning, include proximity to other vehicles 140. As indicated, the processes at blocks 620 through 650 detail the DOO estimation at block 355.

FIG. 7 illustrates estimation of DOO for a grid point 405 as part of reactive field-of-view-based planning according to one or more embodiments. As a comparison of FIG. 5 with FIG. 7 indicates, the eFOV 710 is different than the eFOV 520. This is because the eFOV 701, which is determined in real time during the travel along the route 210, considers dynamic obstructions such as the other vehicle 140 rather than only the static obstructions 220 within the nominal FOV 510. Based on the position of the other vehicle 140 and the resulting eFOV 710, the distance X1 is less in the scenario shown in FIG. 7 than the one shown in FIG. 5. Thus, the DOO calculated according to EQ. 1 is higher than the DOO discussed with reference to FIG. 5. As previously noted, this DOO estimation is done for every grid point 405 representing every position that the vehicle 100 could traverse along the route 210 at the particular second location of interest. The grid points 405 and corresponding DOO estimates are provided as a cost component for cost function optimization (at block 350). The result of the cost function optimization (at block 350) may be modification of the initial path 420 at the second location of interest.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of controlling an autonomous vehicle to travel from an origin to a destination, the method comprising:
determining, using a processor, a route between the origin and the destination using a map;
determining, using the processor, an initial path along the route by optimizing a first cost function, the first cost function including a static cost component at a first set of locations along the route, and the static cost component at each location among the first set of locations along the route corresponding to a change in field of view of one or more sensors of the autonomous vehicle resulting from one or more static obstructions at the location that are indicated on the map; and
controlling the autonomous vehicle to begin the travel on the route along the initial path.

2. The method according to claim 1, further comprising dynamically modifying the initial path in real time during the travel.

3. The method according to claim 2, wherein the modifying the initial path includes optimizing a second cost function in real time.

4. The method according to claim 3, wherein the optimizing the second cost function includes using a dynamic cost component at a second set of locations along the route, the dynamic cost component at each location among the second set of locations along the route corresponding to the change in field of view of the one or more sensors of the autonomous vehicle resulting from one or more static and dynamic obstructions at the location, wherein the dynamic obstructions include other vehicles.

5. The method according to claim 4, wherein the second set of locations and the first set of locations have one or more locations in common.

6. The method according to claim 4, further comprising determining the change in field of view of the one or more sensors of the autonomous vehicle at two or more grid points at each of the second set of locations.

7. The method according to claim 6, further comprising estimating a degree of occlusion at each of the two or more grid points and providing the degree of occlusion at each of the two or more grid points at each of the second set of locations as the dynamic cost component, wherein the estimating the degree of occlusion includes obtaining a harmonic mean.

8. The method according to claim 3, wherein the optimizing the first cost function and the optimizing the second cost function include performing an algorithmic cost minimization process.

9. The method according to claim 1, further comprising determining the change in field of view of the one or more sensors of the autonomous vehicle at two or more grid points at each of the first set of locations.

10. The method according to claim 9, further comprising estimating a degree of occlusion at each of the two or more grid points and providing the degree of occlusion at each of the two or more grid points at each of the first set of locations as the static cost component, wherein the estimating the degree of occlusion includes obtaining a harmonic mean.

11. A system to control an autonomous vehicle to travel from an origin to a destination, the system comprising:
a memory device configured to store a map; and
a controller configured to determine a route between the origin and the destination, to determine an initial path along the route by optimizing a first cost function, the first cost function including a static cost component at a first set of locations along the route, and the static cost component at each location among the first set of locations along the route corresponding to a change in field of view of one or more sensors of the autonomous vehicle resulting from one or more static obstructions at the location that are indicated on the map, and to control the autonomous vehicle to begin the travel on the route along the initial path.

12. The system according to claim 11, wherein the controller is further configured to dynamically modify the initial path in real time during the travel.

13. The system according to claim 12, wherein the controller is configured to modify the initial path by optimizing a second cost function in real time.

14. The system according to claim 13, wherein the controller is configured to optimize the second cost function by using a dynamic cost component at a second set of locations along the route, the dynamic cost component at each location among the second set of locations along the route corresponding to the change in field of view of the one or more sensors of the autonomous vehicle resulting from one or more static and dynamic obstructions at the location, and the dynamic obstructions including other vehicles.

15. The system according to claim 14, wherein the second set of locations and the first set of locations have one or more locations in common.

16. The system according to claim 14, wherein the controller is configured to determine the change in field of view of the one or more sensors of the autonomous vehicle at two or more grid points at each of the second set of locations.

17. The system according to claim 16, wherein the controller is configured to estimate a degree of occlusion at each of the two or more grid points and provide the degree of occlusion at each of the two or more grid points at each of the second set of locations as the dynamic cost component, and estimating the degree of occlusion includes obtaining a harmonic mean

18. The system according to claim 13, wherein the controller is configured to optimize the first cost function and optimize the second cost function by performing an algorithmic cost minimization process.

19. The system according to claim 11, wherein the controller is further configured to determine the change in field of view of the one or more sensors of the autonomous vehicle at two or more grid points at each of the first set of locations.

20. The system according to claim 19, wherein the controller is further configured to estimate a degree of occlusion at each of the two or more grid points and to provide the degree of occlusion at each of the two or more grid points at each of the first set of locations as the static cost component, and estimating the degree of occlusion includes obtaining a harmonic mean.
